(19) United States
(12) Patent Application Publication
(10) Pub. No.: US 2011/0161097 A1
(43) Pub. Date: Jun. 30, 2011

(54) METHODS AND SYSTEMS FOR SCHEDULING APPOINTMENTS IN HEALTHCARE ENVIRONMENTS

(75) Inventors: Stephen Anthony Fox, Barrington, IL (US); Eric Garland, Barrington, IL (US); Kurt Preston, Barrington, IL (US); Luke Sandberg, Barrington, IL (US); Ryan Wayne Gross, Barrington, IL (US); Michael Mercado, Barrington, IL (US)

(73) Assignee: GENERAL ELECTRIC COMPANY, Schenectady, NY (US)

(21) Appl. No.: 12/648,130

(22) Filed: Dec. 28, 2009

(51) Int. Cl. G06Q 10/00; G06Q 50/00

(52) U.S. Cl. 705/2; 705/7.13

(57) ABSTRACT

Methods and systems for scheduling appointments in healthcare environments are described. An example method of scheduling appointments in healthcare environments includes determining a patient's availability and priority level and identifying, based on patient selection, one of a plurality of time slots. Additionally, the example method includes identifying another patient's willingness to reschedule their appointment for compensation if the one of the plurality of time slots is scheduled by the other patient, scheduling the patient in the one of the plurality of time slots using a processor if the one of the plurality of time slots is available or if the other patient has indicated a willingness to reschedule their appointment for compensation and compensating the other patient if the one of the plurality of time slots was previously scheduled by the other patient.

### BACKGROUND

Healthcare environments, such as hospitals and clinics, typically include information systems to assist in scheduling and/or rescheduling appointments for patients. Because of the urgent nature of some appointments, in some instances, patients having scheduled appointments may be required to wait extended periods past the time scheduled for their appointment or the patients may be forcibly rescheduled all together, for example. These types of experiences may have a tendency to lead to negative patient experiences.

### SUMMARY

An example method of scheduling appointments in healthcare environments includes determining a patient's availability and priority level and identifying, based on patient selection, one of a plurality of time slots. Additionally, the example method includes identifying another patient's willingness to reschedule their appointment for compensation if the one of the plurality of time slots was previously scheduled by the other patient, scheduling the patient in the one of the plurality of time slots using a processor if the one of the plurality of time slots is available or if the other patient has indicated a willingness to reschedule their appointment for compensation and compensating the other patient if the one of the plurality of time slots was previously scheduled by the other patient.

An example tangible machine readable medium having instructions stored thereon that, when executed, cause a machine to determine a patient's availability and priority level, to identify, based on patient selection, one of a plurality of time slots and to identify another patient's willingness to reschedule their appointment for compensation if the one of the plurality of time slots was previously scheduled by the other patient. Additionally, the example tangible machine readable medium having instructions stored thereon that, when executed, cause the machine to schedule the patient in the one of the plurality of time slots using a processor if the one of the plurality of time slots is available or if the other patient has indicated a willingness to reschedule their appointment and to compensate the other patient if the one of the plurality of time slots was previously scheduled by the other patient.

An example scheduling system includes a processor configured to schedule one of a plurality of appointments for a user based on the user's availability and the user's priority level and a data store to store data associated with the plurality of appointments. Additionally, the example scheduling system includes a compensator to compensate another patient if the one of the plurality of appointments was previously scheduled by the other patient.

### BRIEF DESCRIPTION OF THE DRAWINGS

FIG. 1 is a block diagram of an example medical information system.

FIG. 2 is a block diagram of an example apparatus that may be used to implement the examples described herein.

FIGS. 3 and 4 are flow diagrams of example methods that can be used to implement the examples described herein.

FIG. 5 is a schematic illustration of an example processor platform that may be used and/or programmed to implement any or all of the example methods and systems described herein.

The foregoing summary, as well as the following detailed description of certain examples, will be better understood when read in conjunction with the appended drawings. For the purpose of illustrating the examples described herein, certain examples are shown in the drawings. It should be understood, however, that the present disclosure is not limited to the arrangements and instrumentality shown in the attached drawings.

### DETAILED DESCRIPTION

Although the following discloses example methods, apparatus, systems, and articles of manufacture including, among other components, firmware and/or software executed on hardware, it should be noted that such methods, apparatus, systems and articles of manufacture are merely illustrative and should not be considered as limiting. For example, it is contemplated that any or all of these firmware, hardware, and/or software components could be embodied exclusively in hardware, exclusively in software, exclusively in firmware, or in any combination of hardware, software, and/or firmware. Accordingly, while the following describes example methods, apparatus, systems, and/or articles of manufacture, the examples provided are not the only way(s) to implement such methods, apparatus, systems, and/or articles of manufacture.

The examples described herein relate to methods and systems that provide greater flexibility to healthcare practitioners and/or patients when scheduling and/or rescheduling appointments. Such an approach promotes positive patient experiences. Specifically, the methods and systems described herein enable patients having appointments the ability to offer their appointment to another patient in exchange for compensation. In some examples, the other patient requesting the scheduled appointment may have a greater priority level and/or have less scheduling flexibility than the patient having the requested appointment, for example. To comply with HIPAA, the examples methods and systems described herein may be coordinated through a central system and, thus, clinical and/or personal information may be kept confidential.

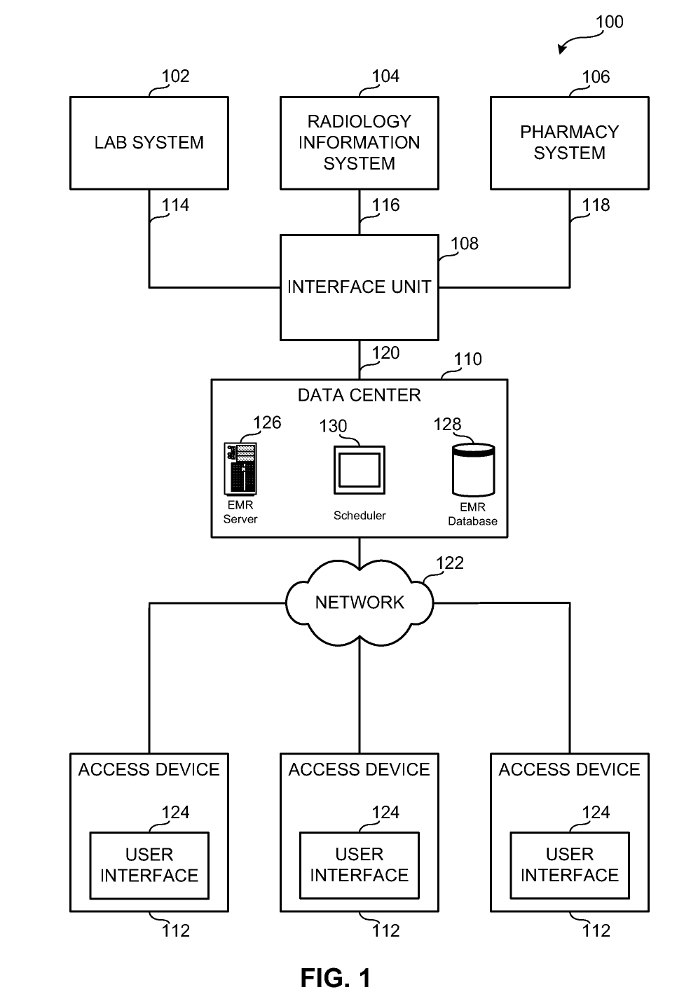

FIG. 1 is a block diagram of an example medical information system 100 capable of implementing the example methods and systems described herein to enable the coordinated rescheduling of appointments for compensation. While the examples described herein are described with reference to healthcare environments, the example systems and methods may be implemented in any other industry such as the hospitality industry (e.g., scheduling hotel reservations), the transportation industry (e.g., scheduling airline tickets), the entertainment industry (e.g., scheduling theater tickets) and/or any other industries in which appointments or reservations are made (e.g., spa appointments, salon appointments, etc.).

The medical information system 100 includes a lab system 102, a radiology information system 104 and a pharmacy system 106. Additionally, the medial information system 100 includes an interface unit 108, a data center 110, and a plurality of access devices 112. In the illustrated example, the lab system 102, the radiology information system 104, and the pharmacy system 106 are housed in a healthcare facility and locally archived. However, in other implementations, the lab system 102, the radiology information system 104, and the pharmacy system 106 may be housed in one or more other suitable locations. Furthermore, one or more components of the medical information system 100 may be combined and/or implemented together. For example, the lab system 102 and/or the radiology information system 104 may be integrated with the pharmacy system 106; the radiology information system 104 may be integrated with the pharmacy system 106; and/or the three example information systems 102, 104 and/or 106 may be integrated together. In other example implementations, the medical information system 100 includes a subset of the illustrated information systems 102, 104 and/or 106. For example, the medical information system 100 may include only one or two of the lab system 102, the radiology information system 104, and the pharmacy system 106. Preferably, information (e.g., test results, observations, diagnosis, etc.) is entered into the lab system 102, the radiology information system 104, and the pharmacy system 106 by healthcare practitioners (e.g., radiologists, physicians, and/or technicians) before, during and/or after a patient examination and/or encounter.

The lab system 102 receives, stores and/or conveys medical information received from, for example, personnel at a hospital, clinic, and/or a physician's office associated with the Clinical Laboratory Department, which includes information related to Anatomic Pathology, Clinical Microbiology, Clinical Biochemistry, Hematology, etc. The radiology information system 104 stores information such as, for example, radiology reports, messages, warnings, alerts, patient scheduling information, patient demographic data, patient tracking information, and/or physician and patient status monitors. Additionally, the radiology information system 104 enables exam order entry (e.g., ordering an x-ray of a patient) and image and film tracking (e.g., tracking identities of one or more people that have checked out a film). In some examples, information in the radiology information system 104 is formatted according to the HL7 (Health Level Seven) clinical communication protocol.

The pharmacy system 106 receives, stores and/or conveys medical information associated with orders for medications. In some examples, the pharmacy system 106 tracks medication orders to completion, generates medical bills associated with the medication dispensed, and monitors and/or controls the inventory in the pharmacy. The pharmacy system 106 interfaces with a number of other systems within the medical information system 100 to receive prescription orders and to generate medical bills associated with the dispensed medication such as, for example, the data center 110 and an insurance system (not shown).

The interface unit 108 includes a lab system interface connection 114, a radiology information system interface connection 116, a pharmacy system interface connection 118, and a data center interface connection 120. The interface unit 108 facilitates communication among the lab system 102, the radiology information system 104, the pharmacy system 106, and/or the data center 110. The interface connections 114, 116, 118, and 120 may be implemented by, for example, a Wide Area Network (WAN) such as a private network or the Internet. Accordingly, the interface unit 108 includes one or more communication components such as, for example, an Ethernet device, an asynchronous transfer mode (ATM) device, an 802.11 device, a DSL modem, a cable modem, a cellular modem, etc. In turn, the data center 110 communicates with the plurality of access devices 112 via a network 122, implemented at a plurality of locations (e.g., a hospital, clinic, doctor's office, other medical office, or terminal, etc.). The network 122 is implemented by, for example, the Internet, an intranet, a private network, a wired or wireless Local Area Network, and/or a wired or wireless Wide Area Network. In some examples, the interface unit 108 also includes a broker (e.g., a Mitra Imaging's PACS Broker) to allow medical information and medical images to be transmitted together and stored together.

In operation, the interface unit 108 receives images, medical reports, administrative information, and/or other clinical information from the information systems 102, 104, 106 via the interface connections 114, 116, 118. If necessary (e.g., when different formats of the received information are incompatible), the interface unit 108 translates or reformats (e.g., into Structured Query Language (SQL) or standard text) the medical information, such as medical reports, to be properly stored at the data center 110. Preferably, the reformatted medical information may be transmitted using a transmission protocol to enable different medical information to share common identification elements, such as a patient name or a social security number. Next, the interface unit 108 transmits the medical information to the data center 110 via the data center interface connection 120. Finally, medical information is stored in the data center 110.

The medical information is later viewable and easily retrievable at one or more of the access devices 112 (e.g., by their common identification element, such as a patient name or a record number). The access devices 112 may be any equipment (e.g., a personal computer, a mobile device) capable of executing software that permits electronic data (e.g., medical reports, data associated with scheduling) and/or electronic medical images (e.g., x-rays, ultrasounds, MRI scans, etc.) to be acquired, stored, or transmitted for viewing and operation. The access devices 112 may receive commands and/or other inputs from a user via, for example, a microphone, a keyboard, a mouse, a track ball, etc. As described in greater detail below, the access devices 112 are capable of implementing a user interface 124 to enable a healthcare practitioner and/or patient to interact with the medical information system 100. For example, in response to a patient entering their availability and/or priority level (e.g., critical level), the user interface 124 may display a plurality of time slots from which the user may choose to schedule their appointment. In such examples, the access device 112 may include one or more options relating to scheduling an appointment.

If the patient selects an appointment that is currently scheduled by another patient and the other patient has indicated a willingness to reschedule their appointment for compensation, the other patient may be rescheduled into a different appointment. Once rescheduled, the user interface 124 (e.g., mobile device) may notify the other patient of the different appointment and/or the compensation received for rescheduling their appointment, for example.

Additionally or alternatively, in response to a category being selected by the healthcare practitioner, the user interface 124 may display exams identified as related to the category. The identified exams may be exams associated with the same patient and/or other patients. In other examples, in response to an input by the healthcare practitioner, the user interface 124 may display previous exams for a patient. In still other examples, the access devices 112 may receive a voice input(s) that relates to an encounter between the healthcare practitioner and a patient. In such examples, the access devices 112 may include one or more options related to generating a text string(s) used to generate a medical report(s). Further, in other examples, the user interface 124 may display a worklist of significant findings.

The example data center 110 of FIG. 1 is an archive to store information associated with scheduling appointments such as, appointments that are available (e.g., available time slots), appointments that are scheduled (e.g., scheduled time slots), the compensation (e.g., an amount or type) requested to reschedule an appointment and/or other time slots that patients having appointments are available to reschedule. Additionally or alternatively, the data center 110 may store information associated with images, data, medical reports, and/or, more generally, patient medical records. In addition, the data center 110 may also serve as a central conduit to information located at other sources such as, for example, local archives, the lab systems, radiology information systems, and/or pharmacy systems (e.g., the lab system 102, the radiology information system 104, and the pharmacy system 106). That is, the data center 110 may store links or indicators (e.g., identification numbers, patient names, or record numbers) to information. In the illustrated example, the data center 110 is managed by an application server provider (ASP) and is located in a centralized location that may be accessed by a plurality of systems and facilities (e.g., hospitals, clinics, doctor's offices, other medical offices, and/or terminals). In some examples, the data center 110 may be spatially distant from the lab system 102, the radiology information system 104, and the pharmacy system 106 (e.g., at a General Electric® facility).

The example data center 110 of FIG. 1 includes an EMR server 126, an EMR database 128 and a scheduler 130. The EMR server 126 receives, processes, and conveys information to and from the components of the medical information system 100. The EMR database 128 stores the information (e.g., medical information, scheduling information) described herein and provides access thereto. The scheduler 130 schedules and/or reschedules appointments for patients. Specifically, based on the determined availability and/or the priority level of a patient, the scheduler 130 may sort, filter and/or group all appointments within a particular time frame (e.g., two weeks, one month, etc.) and have the EMR server 126 convey this information to one of the respective access devices 112 where the plurality of appointments may be viewed by the patient, for example. In some examples, the plurality of appointments may be sorted, filtered and/or grouped based on the patient's availability, the patient's priority level, the priority level of a patient having a scheduled appointment and/or the amount of compensation requested by a patient having a scheduled appointment.

Once the patient has selected an appointment using the access device 112, the scheduler 130 may schedule the patient in the selected appointment and convey information associated with the appointment to the EMR database 128 for storage, for example. If the scheduler 130 determines that the selected appointment is currently scheduled by another patient, the scheduler 130 may automatically schedule the patient into the other patient's appointment if the other patient has indicated a willingness to reschedule their appointment for a predefined compensation, for example.

Additionally or alternatively, the scheduler 130 may contact the other patient using the access device 112 to determine if the other patient is willing to reschedule their appointment for a particular compensation, for example. The other patient may be contacted using e-mail, text messaging, automated messaging or any other known communication methods. If the other patient responds and agrees to reschedule their appointment, the scheduler 130 may schedule the patient in the selected appointment. However, if the other patient responds and refuses to reschedule their appointment, the scheduler 130 may prompt the patient to select a different appointment from the plurality of appointments, for example. In some examples, the patient may select a few (e.g., two or more) appointments from the plurality of appointments and the scheduler 130 may contact the other patients using the access device 112 to determine if the other patients are willing to reschedule their respective appointments for a particular compensation, for example. The patient may be scheduled in the appointment from the other patient willing to reschedule their appointment for compensation, in the appointment from the other patient willing to reschedule their appointment for the least amount of compensation and/or in the appointment from the other patient willing to reschedule their appointment that responds to the request first, for example. If the scheduler 130 determines that the selected appointment is currently scheduled by another patient, the scheduler 130 may schedule the patient into the other patient's appointment if the other patient has a lower priority level than the patient, for example.

If the selected appointment was previously scheduled by another patient, the scheduler 130 may reschedule the other patient into a different time slot and/or have the EMR server 126 convey information associated with the different time slot to the access device 112 to notify the other patient. Additionally or alternatively, if the selected appointment was scheduled by another patient, the scheduler 130 may compensate the other patient and/or change (e.g., increase) the priority level of the other patient once the other patient is rescheduled in a different time slot. By increasing the priority level of the other patient, the examples described herein substantially ensure that a patient having a relatively low priority level is not continuously rescheduled by patients having higher priority level appointments. In some examples, the compensation may be a monetary compensation such as a waiver of a copayment for services rendered or a monetary amount requested by the patient rescheduling their appointment.

Once the patient has scheduled an appointment, the scheduler 130, using patient input entered into the access device 112, may determine if the patient is willing to reschedule their scheduled appointment for compensation. If the patient is willing to reschedule their appointment, the scheduler 130, using patient input entered into the access device 112, may determine an amount of compensation requested to reschedule their appointment and/or other time slots that the patient is available to reschedule their appointment. Such an approach enables appointments to be scheduled and/or rescheduled while maintaining a positive patient experience.

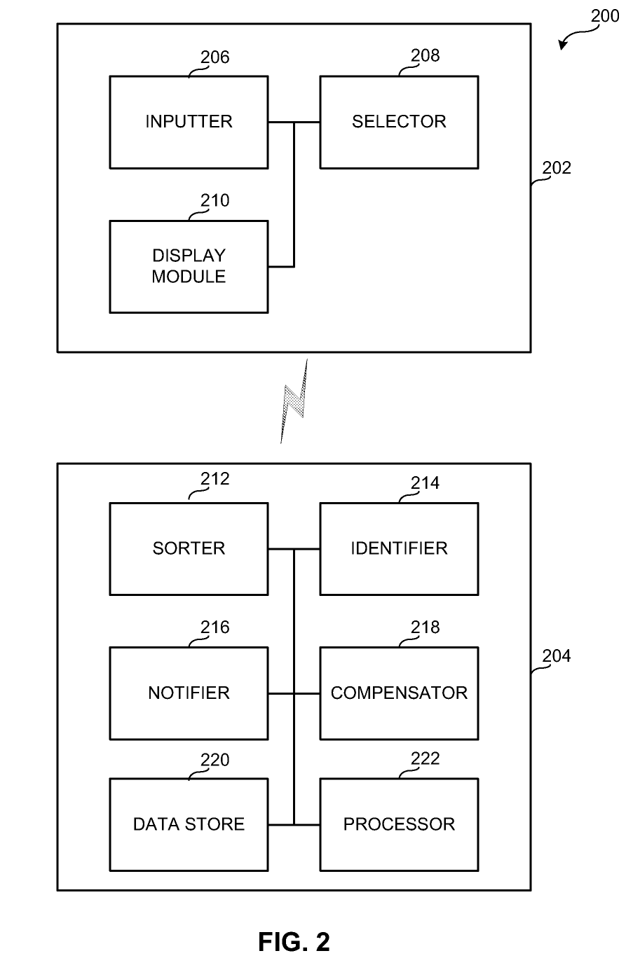

FIG. 2 is a block diagram of an example system 200 for scheduling and/or rescheduling users while maintaining a positive user experience. The example system 200 includes an access device 202 and a scheduler 204. The access device 202 enables a user to input their availability and/or priority level and other associated information and to interact and/or communicate with the scheduler 204. The scheduler 204 may schedule and/or reschedule the user and/or other users based on the user's availability, priority level and other associated information. The access device 202 may be communicatively coupled to the scheduler 204.

The access device 202 may be used to implement the access device 112 of FIG. 1 and the scheduler 204 may be used to implement the scheduler 130 of FIG. 1, for example. The access device 202 may include an inputter 206, a selector 208 and/or a display module 210. The scheduler 204 may include a sorter 212, an identifier 214, a notifier 216, a compensator 218, a data store 220 and/or a processor 222. While an example manner of implementing the access device 112 and the scheduler 130 of FIG. 1 have been illustrated in FIG. 2, one or more of the elements, processes and/or devices illustrated in FIG. 2 may be combined, divided, re-arranged, omitted, eliminated and/or implemented in other ways. Specifically, in some examples, the processor 222 may be integrated into each of the inputter 206, the selector 208, the display module 210, the sorter 212, the identifier 214, the notifier 216, the compensator 218 and/or the data store 220 and, more generally, the example system 200 of FIG. 2 may be implemented by hardware, software, firmware and/or a combination of hardware, software and/or firmware. Thus, for example, any of the inputter 206, the selector 208, the display module 210, the sorter 212, the identifier 214, the notifier 216, the compensator 218, the data store 220 and/or the processor 222 and, more generally, the example system 200 of FIG. 2 can be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended claims are read to cover a purely software and/or firmware implementation, at least one of the inputter 206, the selector 208, the display module 210, the sorter 212, the identifier 214, the notifier 216, the compensator 218, the data store 220 and/or the processor 222 and, more generally, the example system 200 are hereby expressly defined to include a tangible medium such as a memory, DVD, CD, etc., storing the software and/or firmware. Further still, the example system 200 of FIG. 2 may include one or more elements, processes and/or devices in addition to, or instead of, those illustrated in FIG. 2, and/or may include more than one of any or all of the illustrated elements, processes and devices.

In operation, a user (e.g., a patient) may input their availability and/or priority level into the inputter 206 of the access device 202. In other examples, a practitioner (e.g., a healthcare practitioner) may input the user's availability and/or priority level into the inputter 206 based on information obtained from the user and information associated with the user (e.g., the patient medical record), for example. The availability of the patient may include information such as the patient is only available on Tuesday mornings and/or that the appointment must occur on a particular date, for example. The inputter 206 may be, for example, a mouse, joystick, keyboard, track ball, touch activated screen, light wand, voice control or any similar or equivalent input device. Once obtained, the access device 202 may convey the information entered into the inputter 206 to the scheduler 204 where the information may be stored in the data store 220.

The processor 222 may obtain a plurality of appointments from the data store 220 and convey the plurality of appointments and associated information to the sorter 212. The sorter 212 may sort the plurality of appointments based on the user's availability, the user's priority level, the priority level of users having scheduled appointments, the willingness of users having scheduled appointments to reschedule their appointments for compensation and/or the amount of compensation that users having scheduled appointments are requesting to reschedule their appointments. For example, if the sorter 212 sorts the plurality of appointments based on the user's availability, open appointments may be ranked higher than appointment that are scheduled by other users. If the sorter 212 sorts the plurality of appointments based on the user's priority level, other users with scheduled appointments having lower priority levels may be ranked higher than other users with scheduled appointments having higher priority levels, for example. If the sorter 212 sorts the plurality of appointments based on the willingness of users having scheduled appointments to reschedule their appointments for compensation, users indicating a willingness to reschedule their appointment may be ranked higher than users indicating an unwillingness to reschedule their appointment, for example. If the sorter 212 sorts the plurality of appointments based on an amount of compensation that users having scheduled appointments are requesting to reschedule, users requesting less compensation may be ranked higher than users requesting higher compensation, for example. Once sorted, the processor 222 may convey the plurality of sorted appointments to the data store 220 for storage.

The scheduler 204 may then convey the plurality of sorted appointments to the access device 202 where the plurality of sorted appointments can be displayed using the display module 210. After reviewing the plurality of sorted appointments, the user may then select one of the plurality of appointments using the selector 208. The access device 202 may then convey the selected appointment (e.g., an identifier associated with the selected appointment) to the scheduler 204 where the selected appointment may be stored in the data store 220.

The processor 222 may obtain the selected appointment from the data store 220 and convey it to the identifier 214. The identifier 214 may identify whether or not another user is scheduled in the selected appointment. If the identifier 214 identifies that no other patient is scheduled in the appointment, the scheduler 204 may schedule the user in the selected appointment. Specifically, the identifier 214 may convey to the processor 222 that the selected appointment is open and then the processor 222 may schedule the user in the selected appointment. Once scheduled, the information associated with the scheduled appointment and the respective user may be stored in the data store 220.

However, if the identifier 214 identifies that another user is scheduled in the selected appointment, the identifier 214 may identify if the other user is willing to reschedule their appointment for compensation. For example, the other user may have expressed a willingness to reschedule their appointment for a predefined compensation when they initially scheduled their appointment. Additionally or alternatively, the notifier 216 may contact the other user using the access device 202 to determine if they are willing to reschedule their appointment for compensation. In some examples, the other user may be contacted via e-mail, text messaging, automated messaging or any other known communication method such as having an individual call the other user. If the identifier 214 identifies that the other patient is willing to reschedule their appointment for compensation, the scheduler 204 may schedule the user in the selected appointment.

Once the user is scheduled in the selected appointment that was previously scheduled by the other user, the identifier 214 may reschedule the other user into one a plurality of appointments (e.g., a different appointment). In some examples, the one of the plurality of appointments may be an appointment that the other user has indicated (e.g., previously indicated) that they are available to attend. Once the other user is scheduled in the different appointment, the notifier 216 may notify the other user of the different appointment, the processor 222 may change the priority level of the other user and the compensator 218 may compensate the other user, for example. In some examples, the compensator 218 may compensate the other user by assigning an identifier to the other user indicating that the user is entitled to a particular compensation. For example, if the user is a patient in a healthcare facility, the identifier associated with the user may indicate that the user is entitled to not pay a copayment for services rendered at their next appointment. Alternatively, the compensator 218 may immediately compensate the other user by transferring the compensation by mail or wire transfer. The compensation may come from any source such as a healthcare facility or the user requesting the scheduled appointment, for example.

If the identifier 214 identifies that another user is scheduled in the selected appointment and that the other user is unwilling to reschedule their appointment for compensation, the identifier 214 may identify if the other user has a priority level that allows for a reschedule override. A priority level that allows for a reschedule override may be a routine appointment, a non-emergency appointment and/or another user having a lower priority level than the user attempting to schedule their appointment, for example. If the identifier 214 identifies that the other user having the scheduled appointment has a priority level that does not allow for a reschedule override, the scheduler 204 may convey to the access device 202 that the selected appointment is not available and for the user to select another one of the plurality of appointments, for example. However, if the identifier 214 identifies that the other user having the scheduled appointment has a priority level that allows for a reschedule override, the scheduler 204 may schedule the user in the selected appointment.

Once the user is scheduled in the selected appointment that was previously scheduled by the other user, the identifier 214 may identify one a plurality of appointments that the other user may be rescheduled into. The scheduler 204 may then schedule the other user into a different appointment. The notifier 216 may then notify the other user of the different appointment, the processor 222 may change the priority level of the other user and/or the compensator 218 may compensate the other user, for example. If the other user has not identified any other appointments that the other user is available to attend, the notifier 216 may notify the other user using the access device 202 of the scheduling change and/or to determine the availability of the other user to reschedule.

After the user has scheduled an appointment, the access device 202 may determine whether or not the user is willing to reschedule their appointment for compensation using the selector 208. If the user indicates using the selector 208 that they are unwilling to reschedule their appointment, the access device 202 may convey this information to the scheduler 204 where it may be stored in the data store 220. However, if the user indicates using the selector 208 that they are willing to reschedule their appointment for compensation, the access device 202 may then determine other possible appointments that the user is available to attend and the amount of compensation that the user requests for rescheduling their appointment. In some examples, the user may input their rescheduling availability and/or the amount of compensation requested into the inputter 206. Once the user selects their rescheduling availability and the amount of compensation requested, the access device 202 may convey this information to the scheduler 204 where it may be stored in the data store 220.

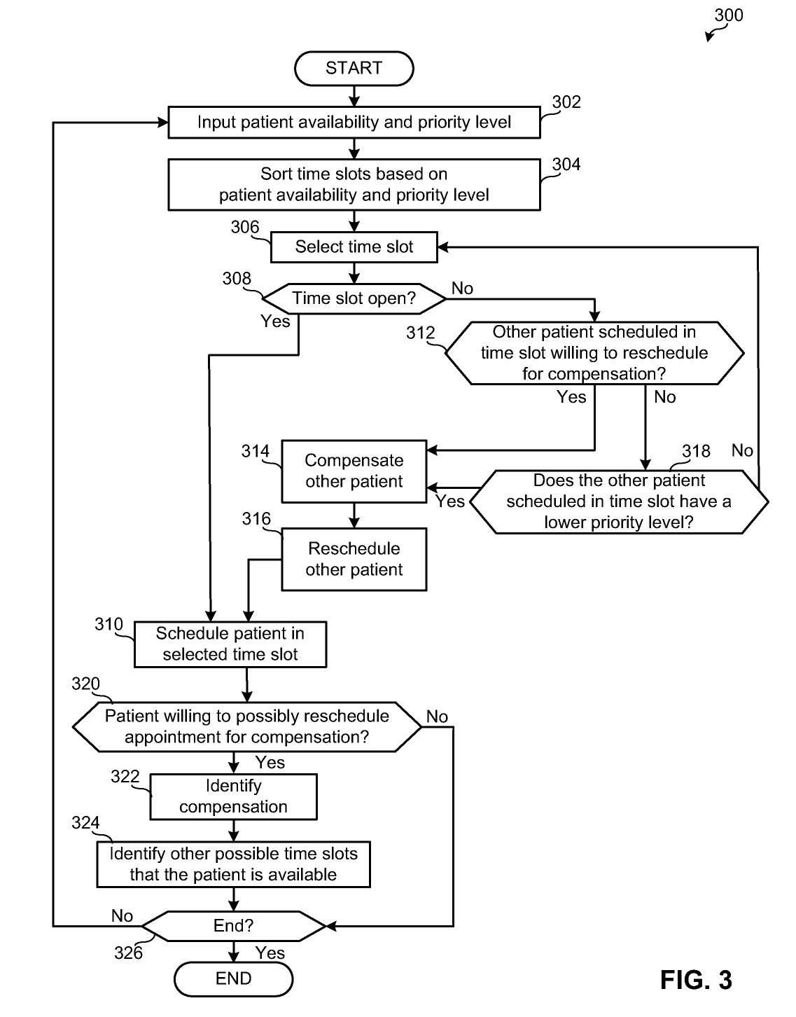

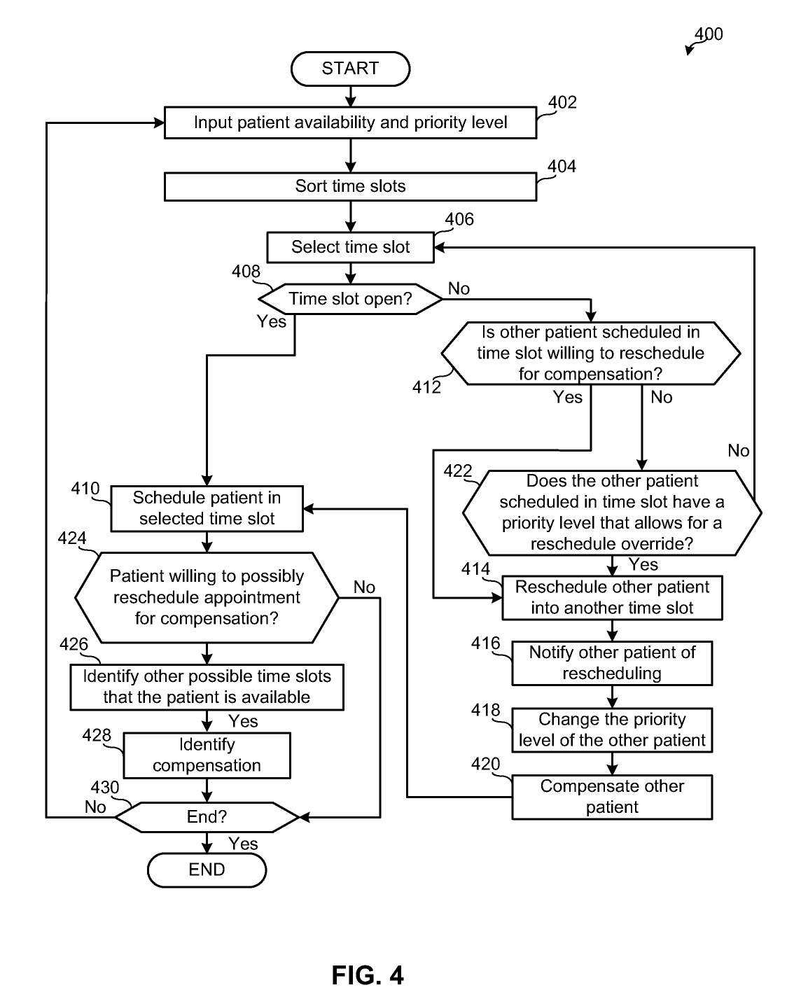

The flow diagrams depicted in FIGS. 3 and 4 are representative of machine readable instructions that can be executed to implement the examples described herein to schedule and/or reschedule patients for appointments while maintaining a positive patient experience. The example processes of FIGS. 3 and 4 may be performed using a processor, a controller and/or any other suitable processing device. For example, the example processes of FIGS. 3 and 4 may be implemented in coded instructions stored on a tangible medium such as a flash memory, a read-only memory (ROM) and/or random-access memory (RAM) associated with a processor (e.g., the example processor 222). Alternatively, some or all of the example processes of FIGS. 3 and 4 may be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example processes of FIGS. 3 and 4 may be implemented manually or as any combination(s) of any of the foregoing techniques, for example, any combination of firmware, software, discrete logic and/or hardware. Further, although the example processes of FIGS. 3 and 4 are described with reference to the flow diagrams of FIGS. 3 and 4, other methods of implementing the processes of FIGS. 3 and 4 may be employed. For example, the order of execution of the blocks may be changed, and/or some of the blocks described may be changed, eliminated, sub-divided, or combined. Additionally, any or all of the example processes of FIGS. 3 and 4 may be performed sequentially and/or in parallel by, for example, separate processing threads, processors, devices, discrete logic, circuits, etc.

Turning to FIG. 3, an example method 300 may begin by inputting the patient's (e.g., a first patient) availability and priority level (block 302). The patient and/or a healthcare practitioner may input the patient's availability and priority level into the access device 112 and/or the inputter 206 of the access device 202. The access device 112 and/or 202 may be a personal computer, a mobile device or any other suitable device that enables a patient to input and/or receive data, for example.

The method 300 may then sort a plurality of time slots based on the patient's availability and the patient's priority level (block 304). The plurality of time slots may be sorted using the scheduler 130 and/or the sorter 212. The scheduler 130 and/or the sorter 212 may sort the plurality of time slots such that open time slots are ranked higher than filled time slots and/or patients having a lower priority appointment are ranked higher than patients having a higher priority appointment, for example. Additionally or alternatively, the method 300 may sort the plurality of time slots such that patients having indicated a willingness to reschedule their appointment are ranked higher than patients having indicated an unwillingness to reschedule their appointment and/or patients willing to accept less compensation to reschedule their appointment are ranked higher than patients requesting more compensation to reschedule their appointment, for example.

The patient and/or the healthcare practitioner may then select one of the plurality of time slots (block 306). The one of the plurality of time slots may be selected using the access device 112 and/or the selector 208 of the access device 202. The method 300 may then determine if the selected time slot is open (block 308) using the scheduler 130 and/or the identifier 214. If the method 300 determines that the time slot is open, control advances to block 310 and the method 300 then schedules an appointment for the patient in the selected time slot (block 310) using the scheduler 130 and/or the processor 222.

If the method 300 determines that the time slot is not open (e.g., the time slot is scheduled by another patient), control advances to block 312. The method 300 then determines whether or not the other patient (e.g., a second patient) having an appointment scheduled in the selected time slot is willing to reschedule their appointment for compensation (block 312). In some examples, the scheduler 130 and/or the identifier 214 may identify that the other patient has expressed a willingness to reschedule their appointment for compensation. Additionally or alternatively, the scheduler 130 and/or the notifier 216 may contact the other patient using the access device 112 and/or 202 to determine and/or inquire into their wiliness and/or the amount of compensation requested to reschedule their appointment. If the patient having an appointment scheduled in the selected time slot indicates that they are willing to reschedule their appointment for compensation, control advances to block 314.

The method 300 may then compensate the other patient (block 314) and reschedule the other patient's appointment into another one of the plurality of time slots (block 316). In some examples, the scheduler 130 and/or the compensator 218 may compensate the other patient by assigning an identifier to the other patient that indicates that the other patient is entitled to a particular compensation such as not paying a copayment for services rendered at their next appointment. The method 300 may reschedule the other patient's appointment into another one of the plurality of time slots by identifying other time slots that the other patient has indicated an availability to attend and/or by contacting the other patient to determine their availability. The other patient may be rescheduled at the same facility or a different facility depending on the other patient's flexibility, for example. Additionally or alternatively, the other patient may be rescheduled by initiating the method 300 for the other patient beginning at block 302.

If the method 300 determines that the other patient is unwilling to reschedule their appointment for compensation, control advances to block 318. Using the scheduler 130 and/or the identifier 214, the method 300 may then determine whether or not the other patient (e.g., the second patient) having an appointment scheduled in the time slot has a lower priority level (block 318) than the patient (e.g., the first patient), for example. If the method 300 identifies that the other patient (e.g., the second patient) having the scheduled appointment in the selected time slot has a priority level that is higher than the patient (e.g., the first patient), control may advance to block 306. The patient may then be prompted by the access device 112 and/or 202 to select another one of the plurality of time slots, because the selected time slot is not available. However, if the method 300 identifies that the other patient (e.g., the second patient) having the scheduled appointment in the selected time slot has a priority level that is lower than the patient (e.g., the first patient), control may advance to block 314. The method 300 may then compensate the other patient (block 314) and reschedule the other patient's (block 316) appointment into another one of the plurality of time slots.

Once the patient (e.g., the first patient) is scheduled in the selected time slot (block 310), control advances to block 320 where the method 300 determines whether or not the patient is willing to possibly reschedule their appointment for compensation (block 320) based on patient input. For example, the patient may be requested to reschedule their appointment if a future patient has a higher priority level than the patient and/or if a future patient is only available during a particular time period, for example. If the patient indicates that they are unwilling to reschedule their appointment, control advances to block 326. However, if the patient indicates that they are willing to possibly reschedule their appointment, control advances to block 322 and the patient and/or healthcare practitioner may determine and/or identify, using patient input, the compensation (e.g., an amount and/or type) to reschedule the patient's appointment (block 322). For example, the patient may input into the access device 112 and/or the inputter 206 that they would be willing to reschedule their appointment for a particular monetary amount (e.g., a price point that must be met for the patient to be willing to reschedule) or incentive and/or a particular priority level in a future appointment(s), for example.

The patient and/or healthcare practitioner may then identify the other possible time slots that the patient is available (block 324) to reschedule their appointment into. In some examples, the patient and/or healthcare practitioner may identify the other possible time slots that the patient is available by entering this information into the access device 112 and/or the inputter 206. The method 300 may then determine whether or not the patient would like to schedule another appointment (block 326); otherwise the example method 300 is ended.

Turning to FIG. 4, an example method 400 may begin by inputting the patient's (e.g., a first patient) availability and priority level (block 402). The patient and/or a healthcare practitioner may input the patient's availability and priority level into the access device 112 and/or the inputter 206 of the access device 202. The access device 112 and/or 202 may be a personal computer, a mobile device or any other suitable device that enables a patient to input and/or receive data, for example.

The method 400 may then sort a plurality of time slots (block 404). The time slots may be time slots into which the patient may schedule an appointment, for example. The plurality of time slots may be sorted using the scheduler 130 and/or the sorter 212. The scheduler 130 and/or the sorter 212 may sort the plurality of time slots such that open time slots are ranked higher than filled time slots and/or patients having a lower priority appointment are ranked higher than patients having a higher priority appointment, for example. Additionally or alternatively, the method 400 may sort the plurality of time slots such that patients having indicated a willingness to reschedule their appointment are ranked higher than patients having indicated an unwillingness to reschedule their appointment and/or patients willing to accept less compensation to reschedule their appointment are ranked higher than patients requesting more compensation to reschedule their appointment, for example.

The patient and/or the healthcare practitioner may then select one of the plurality of time slots (block 406). The one of the plurality of time slots may be selected using the access device 112 and/or the selector 208 of the access device 202. The method 400 may then determine if the selected time slot is open (block 408) using the scheduler 130 and/or the identifier 214. If the method 400 determines that the time slot is open, control advances to block 410 and the method 400 then schedules an appointment for the patient in the selected time slot (block 410) using the scheduler 130 and/or the processor 222.

If the method 400 determines that the time slot is not open (e.g., the time slot is scheduled by another patient), control advances to block 412. The method 400 then determines whether or not the other patient (e.g., a second patient) having an appointment scheduled in the selected time slot is willing to reschedule their appointment for compensation (block 412). In some examples, the scheduler 130 and/or the identifier 214 may identify that the other patient has expressed a willingness to reschedule their appointment for compensation. Additionally or alternatively, the scheduler 130 and/or the notifier 216 may contact the other patient using the access device 112 and/or 202 to determine and/or inquire into their wiliness and/or the amount of compensation requested to reschedule their appointment. If the patient having an appointment scheduled in the time slot indicates that they are willing to reschedule their appointment for compensation, control advances to block 414.

The method 400 may then reschedule the other patient's appointment into another one of the plurality of time slots (block 414) and notify the other patient of the rescheduling (block 416). In some examples, the other patient may be notified of the rescheduling by having the scheduler 130 and/or the notifer 216 contact the other patient using the access device 112 and/or 202. Additionally, the method 400 may change (e.g., increase) the priority level of the other patient (block 418) and compensate the other patient (block 420). By having the scheduler 130 and/or the processor 222 increase the priority level of the other patient, the examples described herein substantially ensure that a patient having a relatively low priority level is not continuously rescheduled by patients having higher priority level appointments, for example.

If the method 400 determines that the other patient is unwilling to reschedule their appointment for compensation, control advances to block 422. Using the scheduler 130 and/or the identifier 214, the method 400 may then determine whether or not the other patient (e.g., the second patient) having an appointment scheduled in the time slot has a priority level that allows for a reschedule override (block 422), for example. If the method 400 identifies that the other patient (e.g., the second patient) having the scheduled appointment in the selected time slot has a priority level that does not allow for a reschedule override, control may advance to block 406. The patient may then be prompted by the access device 112 and/or 202 to select another one of the plurality of time slots, because the selected time slot is not available. However, if the method 400 identifies that the other patient (e.g., the second patient) having the scheduled appointment in the selected time slot has a priority level that allows for a reschedule override, control may advance to block 414. The method 400 may then reschedule the other patient's (block 414) appointment into another one of the plurality of time slots, notify the other patient of the rescheduling (block 416), change the priority level of the other patient (block 418) and/or compensate the other patient (block 420).

Once the patient (e.g., the first patient) is scheduled in the selected time slot (block 410), control advances to block 424 where the method 400 determines whether or not the patient is willing to possibly reschedule their appointment for compensation (block 424) based on patient input. For example, the patient may be requested to reschedule their appointment if a future patient has a higher priority level than the patient and/or if a future patient is only available during a particular time period, for example. If the patient indicates that they are unwilling to reschedule their appointment, control advances to block 430. However, if the patient indicates that they are willing to possibly reschedule their appointment, control advances to block 426 and the patient and/or healthcare practitioner may determine and/or identify, using patient input, the other possible time slots that the patient is available (block 426) to reschedule their appointment into. In some examples, the patient and/or healthcare practitioner may identify the other possible time slots that the patient is available by entering this information into the access device 112 and/or the inputter 206.

The patient and/or healthcare practitioner may determine, using patient input, the compensation (e.g., an amount and/or type) to reschedule the patient's appointment (block 428). For example, the patient may input into the access device 112 and/or the inputter 206 that they would be willing to reschedule their appointment for a particular monetary amount or incentive and/or a particular priority level in a future appointment(s), for example. The method 400 may then determine whether or not the patient would like to schedule another appointment (block 430); otherwise the example method 400 is ended.

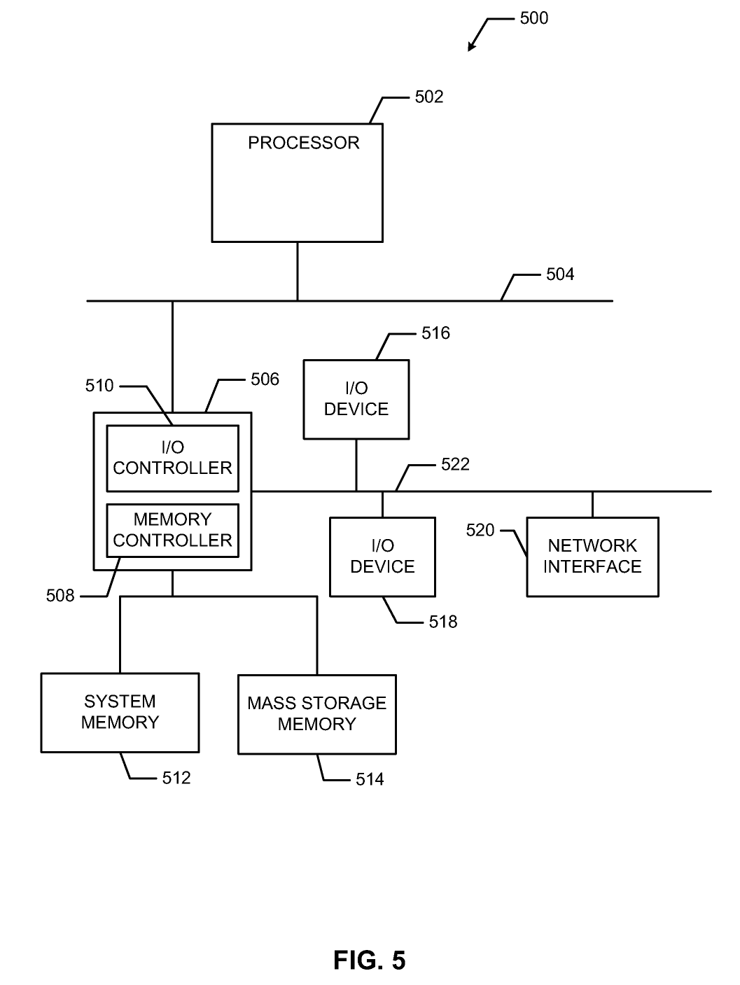

FIG. 5 is a block diagram of an example processor system 500 that may be used to implement the systems and methods described herein. As shown in FIG. 5, the processor system 500 includes a processor 502 that is coupled to an interconnection bus 504. The processor 502 may be any suitable processor, processing unit or microprocessor. Although not shown in FIG. 5, the processor system 500 may be a multi-processor system and, thus, may include one or more additional processors that are identical or similar to the processor 502 and that are communicatively coupled to the interconnection bus 504.

The processor 502 of FIG. 5 is coupled to a chipset 506, which includes a memory controller 508 and an input/output (I/O) controller 510. As is well known, a chipset typically provides I/O and memory management functions as well as a plurality of general purpose and/or special purpose registers, timers, etc. that are accessible or used by one or more processors coupled to the chipset 506. The memory controller 508 performs functions that enable the processor 502 (or processors if there are multiple processors) to access a system memory 512 and a mass storage memory 514.

The system memory 512 may include any desired type of volatile and/or non-volatile memory such as, for example, static random access memory (SRAM), dynamic random access memory (DRAM), flash memory, read-only memory (ROM), etc. The mass storage memory 514 may include any desired type of mass storage device including hard disk drives, optical drives, tape storage devices, etc.

The I/O controller 510 performs functions that enable the processor 502 to communicate with peripheral input/output (I/O) devices 516 and 518 and a network interface 520 via an I/O bus 522. The I/O devices 516 and 518 may be any desired type of I/O device such as, for example, a keyboard, a video display or monitor, a mouse, etc. The network interface 520 may be, for example, an Ethernet device, an asynchronous transfer mode (ATM) device, an 802.11 device, a DSL modem, a cable modem, a cellular modem, etc. that enables the processor system 500 to communicate with another processor system.

While the memory controller 508 and the I/O controller 510 are depicted in FIG. 5 as separate blocks within the chipset 506, the functions performed by these blocks may be integrated within a single semiconductor circuit or may be implemented using two or more separate integrated circuits.

Certain example implementations contemplate methods, systems and computer program products on any machine-readable media to implement functionality described above. Certain example implementations may be implemented using an existing computer processor, or by a special purpose computer processor incorporated for this or another purpose or by a hardwired and/or firmware system, for example.

Certain example implementations include computer-readable media for carrying or having computer-executable instructions or data structures stored thereon. Such computer-readable media may be any available media that may be accessed by a general purpose or special purpose computer or other machine with a processor. By way of example, such computer-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

The example methods and apparatus described herein may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. The example methods and apparatus described herein may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

Although certain methods, apparatus, and articles of manufacture have been described herein, the scope of coverage of this patent is not limited thereto. To the contrary, this patent covers all methods, apparatus, and articles of manufacture fairly falling within the scope of the appended claims either literally or under the doctrine of equivalents.

What is claimed is:

1. A method of scheduling appointments in healthcare environments, comprising:
determining a patient's availability and priority level;
identifying, based on patient selection, one of a plurality of time slots;
identifying another patient's willingness to reschedule their appointment for compensation if the one of the plurality of time slots is scheduled by the other patient;
scheduling the patient in the one of the plurality of time slots using a processor if the one of the plurality of time slots is available or if the other patient has indicated a willingness to reschedule their appointment for compensation; and
compensating the other patient if the one of the plurality of time slots was previously scheduled by the other patient.

2. The method of claim 1, further comprising rescheduling the other patient into a different time slot.

3. The method of claim 2, further comprising notifying the other patient of the different time slot.

4. The method of claim 1, further comprising sorting the plurality of time slots based on at least one of the patient's availability, the patient's priority level, or an amount of compensation requested by the other patient to reschedule their appointment.

5. The method of claim 1, further comprising at least one of filtering or grouping the plurality of time slots based on at least one of the patient's availability, the patient's priority level, or an amount of compensation requested by the other patient to reschedule their appointment.

6. The method of claim 1, further comprising determining if the one of the plurality of time slots is scheduled by the other patient.

7. The method of claim 6, wherein identifying the other patient's willingness to reschedule their appointment for compensation comprises contacting the other patient and inquiring if the other patient is willing to reschedule their appointment for compensation.

8. The method of claim 6, further comprising, if the one of the plurality of time slots is scheduled by the other patient, identifying if the other patient has a lower priority level than the patient.

9. The method of claim 1, further comprising changing the priority level of the other patient.

10. The method of claim 1, further comprising identifying, based on patient input, the patient's willingness to reschedule their appointment for compensation.

11. The method of claim 10, further comprising identifying, based on patient input, an amount of compensation requested to reschedule their appointment.

12. The method of claim 10, further comprising identifying, based on patient input, other time slots that the patient is available to reschedule their appointment.

13. A tangible machine readable medium having instructions stored thereon that, when executed, cause a machine to:
determine a patient's availability and priority level;
identify, based on patient selection, one of a plurality of time slots;
identify another patient's willingness to reschedule their appointment for compensation if the one of the plurality of time slots is scheduled by the other patient;
schedule the patient in the one of the plurality of time slots using a processor if the one of the plurality of time slots is available or if the other patient has indicated a willingness to reschedule their appointment; and
compensate the other patient if the one of the plurality of time slots was previously scheduled by the other patient.

14. The tangible machine readable medium of claim 13 having instructions stored thereon that, when executed, cause the machine to reschedule the other patient into a different time slot.

15. The tangible machine readable medium of claim 14 having instructions stored thereon that, when executed, cause the machine to notify the other patient of the different time slot.

16. The tangible machine readable medium of claim 13 having instructions stored thereon that, when executed, cause the machine to at least one of sort, filter, or group the plurality of time slots based on at least one of the patient's availability, the patient's priority level, or an amount of compensation requested by the other patient to reschedule their appointment.

17. The tangible machine readable medium of claim 13 having instructions stored thereon that, when executed, cause the machine to identify, based on patient input, at least one of an amount of compensation requested to reschedule the patient's appointment or other time slots that the patient is available to reschedule their appointment.

18. A scheduling system, comprising:
a processor configured to schedule one of a plurality of appointments for a user based on the user's availability and the user's priority level;
a data store to store data associated with the plurality of appointments; and
a compensator to compensate another patient if the one of the plurality of appointments was previously scheduled by the other patient.

19. The system of claim 18, wherein the processor is to further reschedule the other user into a different time slot.

20. The system of claim 19, further comprising a notifier to notify the other user of the different time slot.

21. The system of claim 18, wherein the processor is to identify another patient's willingness to reschedule their appointment for compensation if the one of the plurality of time slots is scheduled by the other patient.

22. The system of claim 21, wherein the processor is to contact the other patient and inquire if the other patient is willing to reschedule their appointment for compensation if the one of the plurality of time slots is scheduled by the other patient.
